(19) United States
(12) Patent Application Publication
(10) Pub. No.: US 2014/0298723 A1
(43) Pub. Date: Oct. 9, 2014

(54) SELF-INFILTRATION IRRIGATION, ASSEMBLABLE, OBLIQUELY INSERTED MODULAR MULTIFUNCTIONAL WALL GREENING APPARATUS

(71) Applicant: Shanghai Yine Green Technology Co., Ltd., SHANGHAI (CN)

(72) Inventors: Libin Chen, Shanghai (CN); Yunzhen Chen, Shanghai (CN)

(21) Appl. No.: 14/355,277

(22) PCT Filed: Oct. 29, 2012
(86) PCT No.: PCT/CN2012/083662

§ 371 Date: Apr. 30, 2014

(30) Foreign Application Priority Data
Nov. 2, 2011 (CN) 201110340833.9

(51) Int. Cl. A01G 9/02

(52) U.S. Cl. CPC A01G 9/02
USPC 47/79

(57) ABSTRACT

The present invention discloses a self-infiltration irrigation, assemblable, obliquely inserted modular multifunctional wall greening apparatus comprising a pot body and a case body. A face having a hollowed-out portion allowing the pot body to be inserted into the case body is a front panel. The bottom of the pot body faces down to be obliquely inserted into the interior of the case body from the hollowed-out portion of the front panel. The lower end of the bottom of the pot body inserted into the case body is provided with a water inlet. The upper part of the case body has a water inlet part, the lower part thereof is provided with a water outlet, and the water inlet of the pot body is located between the water outlet and a bottom plate of the case body. The front panel of the case body extends along an outward, obliquely upward direction under the hollowed-out portion to form a bearing part and/or along an inward, obliquely downward direction over the hollowed-out portion to form a limiting stopper to prevent the pot body from falling. The present invention is structurally compact, convenient in assembly, multifunctional, widely applicable, safe and aesthetic, and can realize automatic infiltration irrigation.

### FIELD OF INVENTION

The present invention relates to a technical field of facade planting, and in particular to a self-infiltration irrigation, assemblable, obliquely inserted modular multifunctional wall greening system.

### DESCRIPTION OF RELATED ARTS

Nowadays, land is scarce and expensive and, in particular, urban land used for agriculture and greening is decreasing. However, people in the modern society are all in the pursuit of a good ecological environment and green food. Therefore, the rise of taking full advantage of the three-dimensional space of a building for greening and planting green vegetables and the like are gradually in the making, and people are also becoming familiarized with such concepts as “hanging vegetable garden”, “vertical greening” and the like. Currently, numerous wall greening apparatuses of varying qualities made with a variety of technologies and processes have been released in the market, but these products all suffer from some defects in terms of process and function.

For example, some required a giant frame, so they are complicated in assembly, large in size and costly; some have an unsound, unreasonable and nonuniform irrigation system, so the effects are poor; some have poor performance such as durability, water resistance, fire resistance and the like, thus with great potential safety risk; some have a very small space for the growth of plant roots and can only receive few planting media or even nothing, so they cannot play the role of protecting the plant roots and promoting satisfactory growth of the plants; some have a single function, i.e., they only allow some specific plants to be planted or can only be used in some specific places or can only be used in exhibitions for a short time, and in particular, few wall greening apparatuses can facilitate the planting of vegetables; some are difficult to maintain, require frequent replacement, and have poor aesthetic effects; and so on.

Thus, one of the technical problems required to be solved by persons skilled in the art is how to provide a multifunctional wall greening apparatus which is convenient in assembly, cost-controllable, safe and durable, uniform and reasonable in irrigation, widely applicable, convenient in maintenance, and has a good growth effect.

### SUMMARY OF THE PRESENT INVENTION

The object of the present invention is to provide a self-infiltration irrigation, assemblable, obliquely inserted modular multifunctional wall greening apparatus which is low-cost, self-infiltration irrigation, convenient in assembly, safe and durable, widely applicable, convenient in maintenance and has good growth effect, in order to overcome the abovementioned defects existing in the prior art.

To achieve the abovementioned object, the self-infiltration irrigation, assemblable, obliquely inserted modular multifunctional wall greening apparatus of the present invention comprises a pot body and a case body, a face having a hollowed-out portion allowing the pot body to be inserted on the case body (supplying water to the pot body) being a front panel, a bottom of the pot body facing down to be obliquely inserted into the interior of the case body from the hollowed-out portion of the front panel, a lower end of the bottom of the pot body inserted into the case body being provided with a water inlet, an upper part of the case body having a water inlet part, a lower part thereof being provided with a water outlet, and the water inlet of the pot body being located between the water outlet and a bottom plate of the case body, the front panel of the case body extending along an outward, obliquely upward direction under the hollowed-out portion to form a bearing part and/or along an inward, obliquely downward direction over the hollowed-out portion to form a limiting stopper to prevent the pot body from falling.

Therein, the design that the pot body is obliquely inserted accords with the growth characteristics and habits of plants, so that light illuminating the plants planted in the pot body becomes more uniform, and the plants grow more comfortably and would not fall easily. The bearing part plays a role of holding the upper part of the pot body, and the limiting stopper plays a role of pressing on the lower part of the pot body, both are intended for securely placing the pot body on the case body and preventing the pot body from moving outward or falling. The bearing part further plays a role of preventing water inside the case body from flowing out from the front.

Further, a hollow standpipe is fixedly provided inside the case body, the standpipe is in communication with an exterior space below the case body, and a top of the standpipe forms a water outlet.

Further, the case body is cubical, which has a front panel, a rear plate, a bottom plate and two side plates, and the top of which is hollow to form a water inlet part.

Further, the pot body is cylindrical, and the hollowed-out portion is oval.

Further, two adjacent edges of four edges of the front panel are each provided with a plurality of connecting members for fixation to the front panel of an adjacent wall greening apparatus.

Further, both side edges of the front panel extend toward both sides to form two extension plates on which the connecting members are provided for connecting with left and right adjacent wall greening apparatuses more conveniently, and also being more conducive to combination into an arc or circular wall surface.

Further, an inner side of a bottom end of the front panel and/or the rear plate of the case body extends downward to form bumps for insertion into the top of the case body of an adjacent wall greening apparatus below, so as to be fixed to each other.

Further, over the hollowed-out portion of the front panel along an upward direction and at a corresponding position of an upper half of the rear plate are further provided mounting holes for fixation onto a supporting body via fasteners.

Further, both side plates of the case body are further provided with through holes or top ends of the side plates are provided with indentations, for fastening the case body onto the supporting body via fasteners. Such as a cylindrical supporting body, adjacent wall greening apparatuses can be fixed together onto the cylindrical supporting body via a steel wire passing through the through holes or the indentations.

Further, a fastening means operating window is provided on an upper middle part of the front panel of the case body, and fastening means fixation mouths are provided at positions corresponding to the fastening means operating window on the rear plate.

Further, the hollowed-out portion of the front panel of the case body along an upward direction is provided with a positioning hole; an exterior side of the pot body is provided with a positioning bolt matching the positioning hole.

Further, the hollowed-out portion of the front panel of the case body along an upward direction is provided with a positioning hole; an exterior side of the pot body is provided with a blocking bolt matching the positioning hole.

Further, the rear plate of the case body is provided with an indentation extending from top to bottom; preferably, an outer side of the rear plate of the case body is provided with an indentation notch extending from top to bottom.

Further, positions of the rear plate of the case body corresponding to the two hollowed-out portions case body are respectively provided with fastening means fixation mouths.

Further, a bottom of the pot body is provided with holes having the functions of water penetration and drainage.

Further, the holes comprise pores and elongated pores.

Further, the pores have a pore diameter of between 1.5 mm and 3 mm, preferably of between 1.8 mm and 2.2 mm.

Further, the elongated pores have a width of between 1.5 mm and 3 mm, preferably of between 1.8 mm and 2.2 mm.

Further, the water inlet of the pot body is filled with or covered by a filter cloth for preventing particles inside the pot body from entering the case body and for reducing harmful substances in the water from impairing the planting medium and the plants. Therein, the filter cloth can be a geotextile.

Further, an upper half of the bottom of the pot body inserted into the case body is a slope, which is similar to that a part of the pot body is cut off, and the slope abuts against the rear plate of the case body so that the pot body can be obliquely inserted into the pot body inside the relatively narrow case body.

Further, the major material of the case body and the pot body is PP (polypropylene) or PE (polyethylene), and may also contains one or more of a flame retardant, an anti-UV additive or an antioxidant, in order to adapt to different climatic and environmental conditions and different functional requirements.

The present invention has the following positive and progressive technical effects owing to adoption of the abovementioned technical solution:

1. The present invention is structurally compact, convenient in assembly, safe and less costly. The structure combining a case body and a pot body is used to facilitate assembly and disassembly. Each wall greening apparatus can be lapped over and fixed to each other. Generally, the facade green wall can be secured only by fixing the wall greening apparatuses in the bottom layer and in the top layer to a supporting body by means of fixation orifices of the apparatuses. For some tall green walls, the entire wall greening system can be fixed securely and becomes stable and safe by just appropriately adding some fixation points. Moreover, since a giant skeleton is not required, the cost can be better controlled. Besides, the oblique insertion of the pot body into the case body and the fixation by the bearing part or the limiting stopper not only enable the pot body to become very stable after insertion into the case body, but also facilitate removal of the pot body when necessary.

2. The irrigation system is reasonable, uniform and highly efficient, and the maintenance is very simple and convenient. Each group of the wall greening apparatuses has an independent planting irrigation system. A water pipeline is arranged on the top of the wall greening system. Water in the water pipeline is introduced into the case body from the water inlet part of the wall greening apparatus on the top layer. After the water accumulates on the bottom of the case body and when the water level is higher than the water outlet, water flows toward the case body of the wall greening apparatus below from the water outlet. By analogy, water can be rapidly conducted to the case body of the wall greening apparatus on the lowest layer, and excessive water can also be discharged from the water outlet of the wall greening apparatus on the lowest layer. The water inlet on the bottom of the pot body is located between the bottom plate and the water outlet of the case body, which can allow the moisture to enter the pot body and rise through the capillary of the planting medium inside the pot body, or be absorbed and utilized by the plant, or be transpirated and evaporated to achieve heat exchange. A highly efficient and uniform wall greening infiltration irrigation system is realized through such a reasonable irrigation system. The utilization of a filter cloth to fill or cover the water inlet at the bottom of the pot body not only can prevent particles inside the pot body from entering the case body to induce a sedimentation phenomenon in the case body and damage the infiltration irrigation system, but also can filter the water into the pot body to prevent or delay degradation of the planting medium in the pot body. Further, in specific applications, the time required for each water delivery starting from the beginning to drainage occurring in the case body of the last wall greening apparatus can be determined by carrying out a water delivery test once according to the water velocity, the size and height of the green wall, and the like. In this way, automatic infiltration irrigation is realized by simply carrying out timing control of the water delivery valve. In the event of applying fertilizer, rapid and highly efficient application of fertilizer can be carried out during irrigation simply by adding instant fertilizer in the water source.

3. The present invention is multifunctional, widely applicable and aesthetic, and accords with the growth habits of the plant. The present invention can cultivate flowers and vegetables. The wall greening apparatus can be combined into different shapes such as planes, arcs, circles and the like, so as to be adapted to facade matrices in different shapes such as planes, slopes, curved surfaces, cylinders and the like. The wall greening apparatus can stand against the wall, and can stand by hanging in the air or against a certain supporting body. The front panel of the case body of the wall greening apparatus is lapped over each other, so that the facade matrices such as the case body, the wall body and the like at the back are not visible from outside. Moreover, only a few fixation points can make the entire wall greening system stationary, reliable, stable and safe. Thus, the wall greening apparatus can be applicable to the decorated facade to avoid destruction, and can also be applicable to a variety of rough facade matrices, ensuring the aesthetics of the green wall as a whole. The case body and the pot body of this wall greening apparatus are combined by oblique insertion, which can make the case body very thin (about 5CM). In this way, the wall greening system occupies less space and is compact and aesthetic. This wall greening apparatus can further enable it to have performance such as flame retardancy, resistance to high and low temperatures and the like by changing the raw materials for production, so as to adapt to different climatic and environmental conditions and different functional requirements. The pot body of this wall greening apparatus is made to have a relatively large capacity. Further, as the pot body is in an oblique state, it accords with the growth habit of the plant, and the plant has a good growth effect. Meanwhile, the oblique state of the pot body can also facilitate replacement. Thus, the wall greening apparatus not only can be used for greening, but also can take full advantage of the space to cultivate vegetables, in order to adapt to the emerging requirements of “vertical greenings” and “community vegetable gardens”.

### BRIEF DESCRIPTION OF THE DRAWINGS

To better understand the object, characteristics and advantages of the present invention, the preferred embodiments of the present invention will be described in detail hereinafter in combination with the drawings, wherein:

FIG. 1 is a schematic diagram of the lateral structure of the first embodiment of the wall greening apparatus of the invention;

FIG. 2 is a schematic diagram of the front structure of the first embodiment of the wall greening apparatus of the invention.

FIG. 3 is a schematic diagram of the front structure of the second embodiment of the wall greening apparatus of the invention.

FIG. 4 is a stereogram of the rear structure of the second embodiment of the wall greening apparatus of the invention.

FIG. 5 is a stereogram of the front structure of the second embodiment of the wall greening apparatus of the invention.

### DETAILED DESCRIPTION OF THE PREFERRED EMBODIMENTS

Hereinafter detailed description of one or more embodiments of the present invention is provided in combination with the drawings which explain the principles of the present invention. The present invention is described in combination with these embodiments, but is not limited to any embodiment. The scope of the present invention is only limited by the claims, and the present invention covers many alternative solutions, modifications and equivalents. Many specific details are set forth in the following description to provide a thorough understanding of the present invention. These details are provided for the purpose of examples, and the present invention can be practiced according to the claims in the case of lacking some or all of these specific details. For clarity, the technical materials known in the technical field related to the present invention have not been described in detailed yet, to avoid unnecessarily obscuring the present invention.

### Embodiment 1

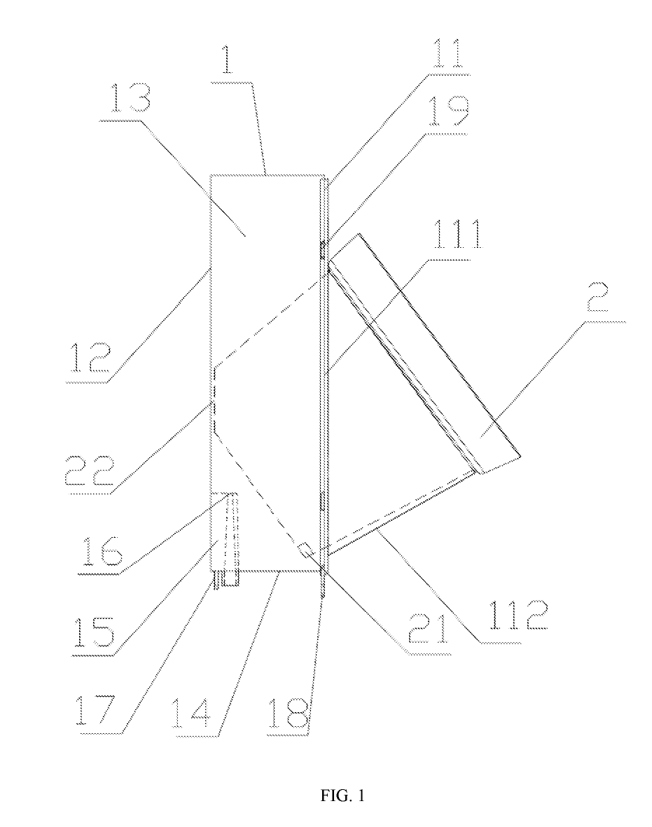

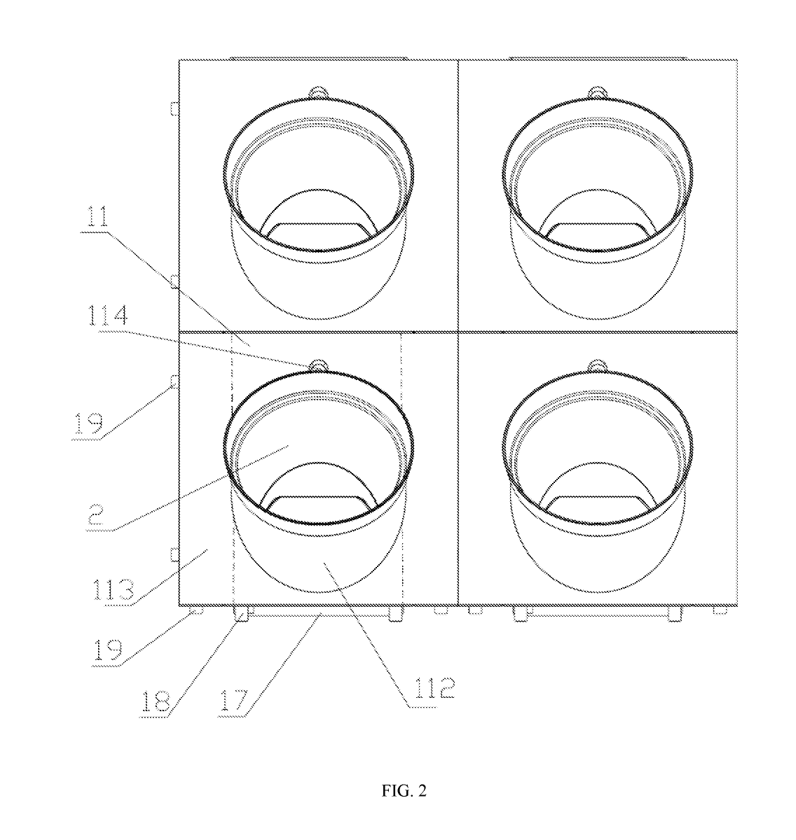

Please refer to both FIG. 1 and FIG. 2. A self-infiltration irrigation, assemblable, obliquely inserted modular multifunctional wall greening apparatus comprises a case body 1 and a pot body 2, a face having a hollowed-out portion 111 allowing the pot body 2 to be inserted on the case body 1 being a front panel 11, a bottom of the pot body 2 facing down to be obliquely inserted into the interior of the case body 1 from the hollowed-out portion 111 of the front panel 11, a lower end of the bottom of the pot body 2 inserted into the case body 1 being provided with a water inlet 21, the water inlet 21 being filled with and covered by a geotextile, so that, on the one hand, particles inside the pot body 2 can be prevented from entering the case body 1 to induce a sedimentation phenomenon in the case body 1 and destroy the infiltration irrigation system and, on the other hand, water entering the pot body 2 can be filtered to reduce harmful substances in the water from damaging the planting medium and the plant and to prevent or delay degradation of the planting medium in the pot body 2.

Therein, the case body 1 consists of a front panel 11, a rear plate 12, a bottom plate 14 and two side plates 13 to form a cubical container for delivery and storage of water. The top of the case body 1 is empty (without a roof) to form a water inlet part. The bottom plate 14 is provided with a hollow standpipe 15 along an upward direction. The standpipe 15 is in communication with the exterior space below the case body 1. The top of the standpipe 15 forms the water outlet 16. A water inlet 21 of the pot body 2 is located between the water outlet 16 and the bottom plate 14 of the case body 1, so that the water inlet 21 can come into contact with the water inside the case body. When water enters constantly from the water inlet part and the water level exceeds the water outlet 16, water is discharged into the case body of an adjacent wall greening apparatus below from the standpipe 15.

The pot body 2 in the present embodiment is cylindrical. The pot body 2 is obliquely inserted into the front panel 11 to prevent the greening, soil and water in the pot body 2 from falling out. The hollowed-out portion 111 is oval. The front panel 11 extends along an outward, obliquely upward direction (i.e., toward the outside of the case body 1) under the hollowed-out portion 111 to form a curved bearing plate 112 to hold the pot body 2. After the bottom of the pot body 2 is inserted into the case body 1, owing to the space limitation, a slope 22 is formed at the upper end of the bottom thereof to abut against the rear plate 12 of the case body 1.

In other embodiments, it is also possible to arrange a curved stopper plate extending along an inward, obliquely downward direction (i.e., toward the inside of the case body) over the hollowed-out portion, to press on the lower part of the pot body.

In the present embodiment, the material selected for the case body 1 and the pot body 2 is PE or PP. At the same time, one or more additives, such as flame retardants, anti-UV additives, antioxidants or the like are added to the materials according to different temperature and functional requirements of the sites where the apparatus is used.

In the application of a facade wall greening system, as in FIG. 2, two adjacent edges, left and down, of the front panel 11 of the case body 1 are each provided with two connecting members 19. Both sides of the front panel 11 extend toward both sides to form two extension plates 113 so as to be connected to the extension plates of the front panels of left and right adjacent wall greening apparatuses. The inner side of the front panel 11 of the case body 1 extends downward to form a bump 18, and the inner side of the rear plate 12 extends downward to form a rib 17. The widths of the bump 18 and the rib 17 are set to be exactly the width of the inner wall of the case body. That is, the bump 18 and the rib 17 are formed by extending out along the inner angle of the case body. The connecting members 19 at the lower edge of the front panel 11 are connected to the front panel of the adjacent wall greening apparatus below. Meanwhile, both the bump 18 and the rib 17 are formed inwardly along the inner angle of the case body, so that they can be inserted into the top of the case body below and can allow the case body to be limited from front and back and from left and right. In this way, the entire wall greening apparatus is fixed in six directions, up and down, front and back, and left and right.

As for the wall greening apparatuses at the uppermost and lowermost rows of the entire wall greening system, by drilling fasteners into the mounting holes 114 over the hollowed-out portions of their front panels along an upward direction and into the holes at the corresponding positions on the upper parts of the rear plates of the case bodies can all the wall greening apparatuses be fixed onto the supporting body. When necessary, if the wall greening system is taller, fasteners can also be used for fixation on the wall greening apparatuses in the middle, so as to enhance the firmness of the entire wall greening system.

In the application of a cylindrical wall greening system, through holes are provided on the side plates of the case bodies of the wall greening apparatuses on the uppermost row and the lowermost row, so that steel wires penetrate thereinto for fixation onto the cylindrical supporting body. When necessary, through-holes or indentations can also be provided on several rows of the wall greening apparatuses in the middle for reinforcement.

### Embodiment 2

On the basis of embodiment 1 and on the basis of the overall inventive concept, the configuration of the pot body 2 and the relationship between the pot body 2 and the case body 1 can be in other combinations. There may be other ways to fix the case body 1 to the supporting body. For example, the case body 1 can be fixed onto similar facades such as a skeleton, a wall surface or the like via a fastener, or the case body 1 is first fixed onto the skeleton and then fixed onto the wall surface or other similar facades via the skeleton.

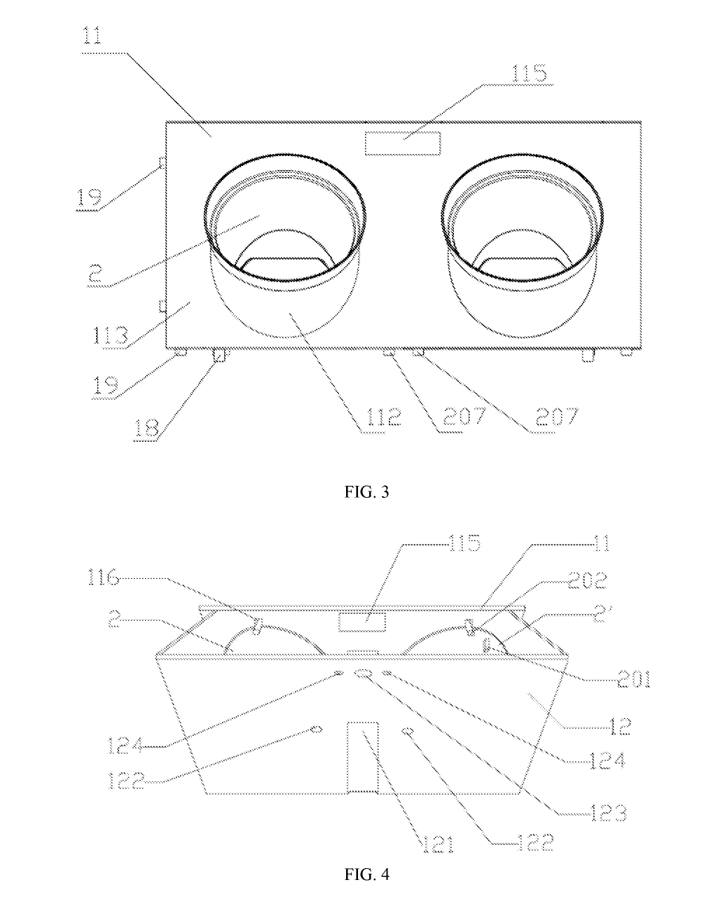

Please refer to FIG. 3 to FIG. 5 for other embodiment modes of the self-infiltration irrigation, assemblable, obliquely inserted modular multifunctional wall greening apparatus. Therein, each unit comprises a case body 1 and two pot bodies, i.e., pot body 2 and pot body 2′, wherein a face having two hollowed-out portions allowing the pot body 2 and the pot body 2′ to be inserted on the case body 1 is a front panel 11, and the bottoms of the pot body 2 and the pot body 2′ face down to be obliquely inserted into the interior of the case body 1 from the hollowed-out portions 111 of the front panel 11. In the actual process of installation, according to actual requirements, each of the units can also comprise a case body 1 and two pot bodies 2, or comprise a case body 1 and two case bodies 2′. Persons skilled in the art, according to actual requirements, can also carry out any combination and splicing by adjusting the sizes of the wall greening apparatus casted in embodiment 1 and the wall greening apparatus casted in the present embodiment.

In the present embodiment, a positioning bolt 202 is provided on an exterior side of the pot body 2, and a blocking bolt 201, in addition to the positioning bolt 202, is further provided on the exterior side of the pot body 2′. In the actual process of installation and operation, with respect to the pot body provided with a positioning bolt 202, like the pot body 2, it is required to insert the positioning bolt 202 into a positioning hole 116 when the pot body 2 is inserted into the hollowed-out portion of the case body 1. With respect to the pot body like the pot body 2′ which is provided with both a positioning bolt 202 and a blocking bolt 201, it is required, during installation, to first insert the blocking bolt 201 into the positioning hole 116, and then rotate the pot body 2′ to further insert the positioning bolt 202 into the positioning hole 116. The positioning hole 116 matches the positioning bolt 201 and the blocking bolt 202. The design of the positioning hole cooperating with the positioning bolt can play a role of fixing the pot body into the case body, and the blocking bolt has theftproof performance.

Refer to FIG. 3 and FIG. 4. A rectangular fastening means operating window 115 is provided between two hollowed-out portions of the front panel 11 and on the upper part of the front panel 11. A primary fastening means fixation mouth 123 and two secondary fastening means fixation mouths 124 are provided at the locations corresponding thereto on the rear plate 12. In actual installation, the operator can fix the case body onto the supporting body through the fastening means operating window 115 by screws or other fasteners, thereby realizing fixation of the entire wall greening apparatus onto the supporting body. In the process of actual operation, a cover (not shown) matching the fastening means operating window can also be arranged.

In the actual process of installation and operation, a plurality of wall greening apparatuses as illustrated in FIG. 3 can be directly fixed from top to bottom by a keel. In this way, the on-site operation can be facilitated, the labor cost is saved, and the fixation on some uneven wall surfaces is also facilitated. Moreover, they can also be easily combined into an arc shape, a cylinder shape or the like. Referring to FIG. 4, an indentation 121 extending from top to bottom can also be provided on the rear plate 12, so that the flatness of the case body 1 can be ensured during fixation when there are some bumps such as screwheads on the supporting body. As illustrated in FIG. 3, fastening means fixation mouths 122 are further provided respectively at the positions corresponding to the two hollowed-out portions on the rear plate 12. In actual installation, the operator can also fix the case body onto the supporting body by expansion screws or other fasteners through the fastening means fixation mouths 122 to realize fixation of the wall greening apparatuses. Thus, with respect to the case body of the present invention, persons skilled in the art can arrange any one or more combinations of the primary fastening means fixation mouth 123, the secondary fastening means fixation mouths 124 and the fastening means fixation mouths 122 of the case body 1.

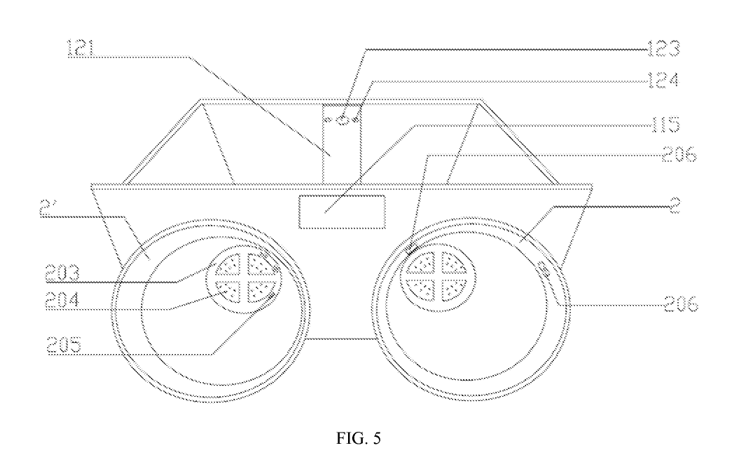

FIG. 5 shows an internal configuration diagram of the pot body 2 and the pot body 2′. As can be seen from FIG. 5, a plurality of pores 204 are provided on the bottom 203 of the pot body 2, and a plurality of elongated pores 205 along the edge of the bottom of the pot body are further provided, in addition to a plurality of pores 204, on the bottom 203 of the pot body 2′. The pores 204 and the elongated pores 205 can rapidly drain excessive water poured from the mouth of the pot. These pores function as water inlets at the same time. The pores are uniformly distributed on the bottom of the pot body. The pores have a pore diameter of 1.8˜2.2 mm. The pore diameter of the pores can not only reduce the medium in the pot body from flowing into the case body, but also ensure that the pores are not blocked.

The elongated drainage holes 205 aim to ensure that timely drainage and water penetration can still be ensured after the pores 204 are blocked. The width of the elongated drainage holes 205 is in the range of 1.8˜2.2 mm. FIG. 5 also shows that the upper edge of the pot body 2 is provided with two fixation openings 206 which can be used to fix the pot body into the case body through a ribbon, a rope or the like to further reinforce the pot body and realize a further theftproof function.

In the wall greening apparatus formed by a case body and two corresponding pot bodies as illustrated in the present embodiment, the bottom of the case body is provided with two adjacent drain pipes 207 which are located between the pot body 2 and the pot body 2′. The two drain pipes are arranged to ensure timely drainage.

Though the aforesaid embodiments have been described in details to some extent for the purpose of clear understanding, the present invention is not limited to the details provided. There are many alternative modes to implement the present invention. The embodiments disclosed are illustrative rather than restrictive.

What is claimed is:

1. A self-infiltration irrigation, assemblable, obliquely inserted modular multifunctional wall greening apparatus, characterized in that: the apparatus comprises a pot body and a case body, a face having a hollowed-out portion allowing the pot body to be inserted into the case body being a front panel, a bottom of the pot body facing down to be obliquely inserted into the interior of the case body from the hollowed-out portion of the front panel, a lower end of the bottom of the pot body, which is inserted into the case body, is provided with a water inlet, an upper part of the case body having a water inlet part, a lower part thereof being provided with a water outlet, and the water inlet of the pot body being located between the water outlet and a bottom plate of the case body, the case body consisting of a front panel, a rear plate, a bottom plate and two side plates to form a container for delivery and storage of water at the bottom, the front panel of the case body extending along an outward, obliquely upward direction under the hollowed-out portion to form a bearing part and/or along an inward, obliquely downward direction over the hollowed-out portion to form a limiting stopper to prevent the pot body from falling.

2. The self-infiltration irrigation, assemblable, obliquely inserted modular multifunctional wall greening apparatus according to claim 1, characterized in that: a hollow standpipe is fixedly provided inside the case body, the standpipe is in communication with an exterior space below the case body, and a top of the standpipe forms the water outlet.

3. The self-infiltration irrigation, assemblable, obliquely inserted modular multifunctional wall greening apparatus according to claim 2, characterized in that: the case body is cubical, which has a front panel, a rear plate, a bottom plate and two side plates, and the top of which is hollow to form a water inlet part.

4. The self-infiltration irrigation, assemblable, obliquely inserted modular multifunctional wall greening apparatus according to claim 3, characterized in that: two adjacent edges of four edges of the front panel are each provided with a plurality of connecting members for fixation to the front panel of an adjacent wall greening apparatus.

5. The self-infiltration irrigation, assemblable, obliquely inserted modular multifunctional wall greening apparatus according to claim 4, characterized in that: both side edges of the front panel extend toward both sides to form two extension plates on which the connecting members are provided for connection to left and right adjacent wall greening apparatuses.

6. The self-infiltration irrigation, assemblable, obliquely inserted modular multifunctional wall greening apparatus according to claim 3, characterized in that: an inner side of a bottom end of the front panel and/or the rear plate of the case body extends downward to form bumps for insertion into the top of the case body of an adjacent wall greening apparatus below, so as to be fixed to each other.

7. The self-infiltration irrigation, assemblable, obliquely inserted modular multifunctional wall greening apparatus according to claim 6, characterized in that: over the hollowed-out portion of the front panel along an upward direction and at a corresponding position of an upper half of the rear plate are further provided mounting holes for fixation onto a supporting body via fasteners.

8. The self-infiltration irrigation, assemblable, obliquely inserted modular multifunctional wall greening apparatus according to claim 3, characterized in that: both side plates of the case body are further provided with through holes or top ends of both side plates of the case body are provided with indentations, for fixation onto a supporting body via fasteners.

9. (canceled)

10. (canceled)

11. (canceled)

12. (canceled)

13. (canceled)

14. (canceled)

15. (canceled)

16. (canceled)

17. The self-infiltration irrigation, assemblable, obliquely inserted modular multifunctional wall greening apparatus according to claim 1, characterized in that: the water inlet of the pot body is filled with or covered by a filter cloth.

18. The self-infiltration irrigation, assemblable, obliquely inserted modular multifunctional wall greening apparatus according to claim 17, characterized in that: the filter cloth is a geotextile.

19. The self-infiltration irrigation, assemblable, obliquely inserted modular multifunctional wall greening apparatus according to claim 1, characterized in that: the case body and the pot body are made of PP or PE.

20. The self-infiltration irrigation, assemblable, obliquely inserted modular multifunctional wall greening apparatus according to claim 19, characterized in that: the case body and the pot body further contain one or more of a flame retardant, an anti-UV additive or an antioxidant.
